(19) United States
(12) Patent Application Publication
(10) Pub. No.: US 2021/0224799 A1
(43) Pub. Date: Jul. 22, 2021

(54) ENTRY POINT MANAGEMENT

(71) Applicant: Wells Fargo Bank, N.A., San Francisco, CA (US)

(72) Inventors: Christina Zappala Ongpin, Burlingame, CA (US); Bryan Kroll, San Mateo, CA (US)

(21) Appl. No.: 15/190,890

(22) Filed: Jun. 23, 2016

(51) Int. Cl. G06Q 20/40; H04L 29/06

(52) U.S. Cl. CPC G06Q 20/40; H04L 63/0861; H04L 2463/102; G06F 2221/2103; H04L 63/10

(57) ABSTRACT

Entry point management and dynamic cross-channel authorization token management is provided. Information related to available authentication tokens and customer data, both historical and current, is obtained and an authentication risk score is determined. Based on the authentication risk score and the available authentication tokens, one or more authentication challenges are rendered based on an attempt to access a customer account. The authentication challenges are independent of the access channel.

### BACKGROUND

For various online applications, a user enrolls in order to access the features of the online application. To enroll, the user may provide information, answers to security questions, answers to questions only the user should know, and so on. In addition, a password or other type of security feature may be established for the user to access the online application and/or perform various functions within the online application. If a fraudster is able to obtain some of the user's information during the registration process or at any time thereafter, the fraudster may be able to access the user's account with a limited amount of information. On the user side, compromised online accounts have been blamed for user dissatisfaction. On the network side, compromised data may be costly and should be mitigated in order to maintain the integrity of the online application.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The various aspects provided herein are related to entry point management. An aspect relates to a system that includes a processor and a memory that stores executable instructions that, when executed by the processor, facilitate performance of operations. The operations may include storing information related to a set of authentication tokens that are available for a customer. The set of authentication tokens may include authentication tokens across all access channels accessible by the customer. The operations may also include storing data related to the customer. The data may be classified based on a level of trust assigned to the data. The operations may also include determining an authentication risk score based on the information related to the set of authentication tokens and the data related to the customer. Further, the operations may include outputting an authentication challenge based on the set of authentication tokens and the authentication risk score. The authentication challenge is independent of an access channel.

Another aspect relates to a method that may include retaining, by a system comprising a processor, information related to a set of authentication tokens available for a customer and data related to the customer in a central repository. The method may also include determining, by the system, an authentication risk score based on the information related to the set of authentication tokens and the data related to the customer. Further, the method may include selecting, by the system, an authentication challenge based on the set of authentication tokens and the authentication risk score. In addition, the method may include outputting the authentication challenge based on a determination that an attempt to access a financial account of the customer has been requested.

A further aspect relates to a computer-readable storage device that stores executable instructions that, in response to execution, cause a system comprising a processor to perform operations. The operations may include storing information related to a set of authentication tokens that are available for a customer. The set of authentication tokens include authentication tokens across all access channels accessible by the customer, and the information includes historical information and current information for the set of authentication tokens. The operations may also include storing data related to the customer. The data is classified based on a level of trust assigned to the data, and the data includes historical data and current data related to the customer. The operations may also include determining in substantially real-time an authentication risk score based on the information related to the set of authentication tokens and the data related to the customer. Further, the operations may include outputting an authentication challenged selected based on the set of authentication tokens and the authentication risk score. The authentication challenge is independent of an access channel.

To the accomplishment of the foregoing and related ends, certain illustrative aspects of the innovation are described herein in connection with the following description and the annexed drawings. These aspects are indicative, however, of but a few of the various ways in which the principles of the innovation may be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

Various non-limiting embodiments are further described with reference to the accompanying drawings in which:

FIG. 1 illustrates an example, non-limiting system configured for entry point management, according to an aspect;

FIG. 2 illustrates examples of traditional authentication challenge types for different access channels;

FIG. 3 illustrates example, non-limiting inputs for a customer authentication rules engine, according to an aspect;

FIG. 4 illustrates an example, non-limiting system for dynamic cross-channel authorization token management, according to an aspect;

FIG. 5 illustrates example, non-limiting authentication challenges that may be utilized with the disclosed aspects;

FIG. 6 illustrates an example, non-limiting system that employs automated learning to facilitate one or more of the disclosed aspects;

FIG. 7 illustrates an example, non-limiting method for entry point management, according to an aspect;

FIG. 8 illustrates an example, non-limiting method for dynamic cross-channel authorization token management, according to an aspect;

FIG. 9 illustrates an example, non-limiting computer-readable medium or computer-readable device including processor-executable instructions configured to embody one or more of the aspects set forth herein; and

FIG. 10 illustrates an example, non-limiting computing environment where one or more of the aspects set forth herein are implemented, according to one or more aspects.

### DETAILED DESCRIPTION

The innovation is now described with reference to the drawings. In the following description, for purposes of explanation, numerous specific details are set forth in order to provide a thorough understanding of the subject innovation. It may be evident, however, that the innovation may be practiced without these specific details. In other instances, well-known structures and devices are shown in block diagram form in order to facilitate describing the innovation.

Traditionally, financial entities may rely on several authentication methods and challenges to validate customers attempting transactions and events. However, these challenges may be static in nature. For example, if the transaction is a certain transaction type, then a pre-specified authentication is used instead of using another type of authentication. Thus, the pre-established transaction type/authentication method pairing becomes predictable and as fraud and phishing attacks become more sophisticated, fraudsters have learned to anticipate the authentication method(s) that will be rendered during each challenge. Based on the educated deduction, the fraudsters may be able to shift their strategies to overcome the authentication challenges and gain fraudulent access to a customer's account.

Various aspects described herein relate to an authentication presentment engine that renders authentication challenges to a customer based on the type of transaction, level of trust with the customer, or based on other considerations. According to an additional or alternative implementation, the authentication challenge rendered may be based on past authentication challenge types presented to the customer. As used herein a “customer” refers to a user that is a customer of the financial institution and/or one or more devices managed by the customer. In some aspects, the user or customer may be a rogue user attempting to fraudulently gain financial access by impersonating actual customers of the financial institution.

According to a use case example for enrollment, Advanced Access (AA) and/or One-Time Passcode (OTP) are traditionally not utilized for online banking enrollment due to the potential of compromise and no downstream challenge mechanisms in place to detect fraud or risk should AA/OTP for the customer be compromised. According to various aspects disclosed herein, the customer may enroll in online banking and if the enrollment is deemed suspicious due to device or Internet Protocol (IP) flag, an authentication presentment engine might request additional information from the customer. For example, the customer may need to successfully pass both AA and OTP as well as an additional authentication challenge (e.g., product hierarchy) to complete the enrollment. According to another example, the customer may need to successfully pass both AA and OTP to complete the enrollment and a flag is set at login for the customer to pass a second authentication challenge (e.g., product hierarchy or biometrics).

According to a use case example for challenge presentment, the authentication presentment engine, as discussed herein, may track the number of challenges by type presented to a customer. Rules within the engine may trigger a different authentication challenges to be used for every X number of AA/OTP challenges. For example within the last six months a customer has been presented and successfully passed four AA/OTP challenges and is attempting a transaction type that normally relies on AA/OTP. The authentication presentment determines this is the fifth challenge and assesses the transaction type, customer trust level, and presents a different authentication method to that customer, which helps mitigate predictability of the authentication methods.

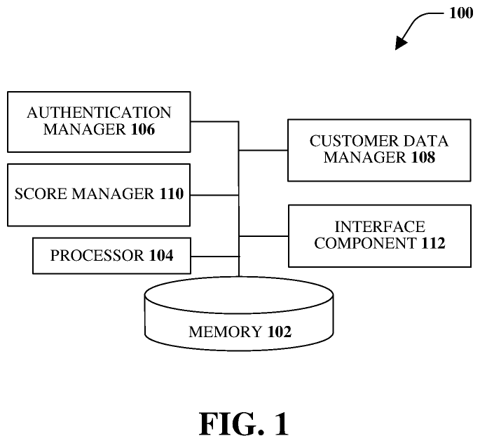

FIG. 1 illustrates an example, non-limiting system 100 configured for entry point management, according to an aspect. It is noted that although the various aspects may be described with respect to a financial entity, the disclosed aspects are not limited to this implementation. Instead, the various aspects may be modified such that organizations, companies, and so on, may utilized the aspects presented herein. As used herein an “entity” or “financial entity” refers to a financial institution, such as a bank, persons operating on behalf of the financial institution, and/or communication devices managed by the financial institution and/or the persons operating on behalf of the financial institution. Additionally or alternatively, the entity may be a third party monitoring source or another type of entity that has a trusted relationship with the financial institution.

The system 100 may include at least one memory 102 that may store computer executable components and/or computer executable instructions. The system 100 may also include at least one processor 104, communicatively coupled to the at least one memory 102. The at least one processor 104 may facilitate execution of the computer executable components and/or the computer executable instructions stored in the at least one memory 102. The term “coupled” or variants thereof may include various communications including, but not limited to, direct communications, indirect communications, wired communications, and/or wireless communications.

It is noted that although the one or more computer executable components and/or computer executable instructions may be illustrated and described herein as components and/or instructions separate from the at least one memory 102 (e.g., operatively connected to the at least one memory 102), the various aspects are not limited to this implementation. Instead, in accordance with various implementations, the one or more computer executable components and/or the one or more computer executable instructions may be stored in (or integrated within) the at least one memory 102. Further, while various components and/or instructions have been illustrated as separate components and/or as separate instructions, in some implementations, multiple components and/or multiple instructions may be implemented as a single component or as a single instruction. Further, a single component and/or a single instruction may be implemented as multiple components and/or as multiple instructions without departing from the example embodiments.

The system 100 may also include an authentication manager 106 that may be configured to maintain information related to customer authentication tokens that are available for customers. The tokens available include all authentication tokens regardless of the channel used by the customer to access various accounts or perform interactions. As used herein an “interaction” may be any touch point or transaction between the financial entity and the customer.

Thus, a first customer may have a first set of available authentication tokens, a second customer may have a second set of available authentication tokens, a third customer may have a third set of available authentication tokens, and so on. The authentication tokens that are available for each customer may be based upon the type of accounts associated with the customer, devices associated with the customer, and so forth.

A device may also be called, and may contain some or all of the functionality of a system, subscriber unit, subscriber station, mobile station, mobile, mobile device, wireless terminal, device, remote station, remote terminal, access terminal, user terminal, terminal, wireless communication device, wireless communication apparatus, user agent, user device, or user equipment (UE). A mobile device may be a cellular telephone, a cordless telephone, a Session Initiation Protocol (SIP) phone, a smart phone, a feature phone, a wireless local loop (WLL) station, a personal digital assistant (PDA), a laptop, a handheld communication device, a handheld computing device, a netbook, a tablet, a satellite radio, a data card, a wireless modem card, and/or another processing device for communicating over a wireless system. Further, although discussed with respect to wireless devices, the disclosed aspects may also be implemented with wired devices, or with both wired and wireless devices.

Also included in the system 100 may be a customer data manager 108 that may be configured to retain data related to the customer. The data may include current data, including, for example, a current phone number(s), a current email address(es), established security questions, and so forth. The data may also include historical information, including, for example, a previous token used, whether the user successfully answered a previous security challenge, a last time contact information of the customer was changed, and so on. According to some implementations, the data may include device data, such as device type, a software update date, the version of software installed in the device, an identification associated with the device, and other data related to the device.

The customer data manager 108 may also be configured to determine whether the data associated with the customer is trusted or is suspect (e.g., not trusted). For example, if the customer's account is associated with a phone number, an independent verification may be performed to determine if the phone number is owned by (or connected to) the customer. In another example, a voiceprint of the customer may have been recorded and verified by a person that personally knows the customer (and is trusted by the financial entity).

A score manager 110 may be configured to determine an authentication risk score. The authentication risk score may be determined in substantially real-time (e.g., at about the same time as a request for access is received) or at a different time. For example, if the customer data manager 108 validates the phone number as trusted (e.g., based on a vendor or third-party source relationship), this may have a positive impact to the score. If the customer data manager 108 has a trusted voiceprint on file, which is a strong authentication, it may have a positive impact to the score. Information that may have a negative impact to the score may include recent address changes, recent phone number changes, if a Personal Identification Number (PIN) pin was suspended recently (indicates too many failed access attempts), and so on.

Based at least in part on the score determined by the score manager 110, an interface component 112 may be configured to output one or more authentication challenges to the customer. The determination as to which authentication challenge to output may be dynamic and is independent of the channel being used by the customer. Thus, the authentication challenges are interchangeable among the different channels. For example, if the customer has recently failed a PIN challenge, at the next log in attempt, regardless of the channel being used, the customer may be presented with two challenges, neither of which are the PIN challenge.

According to some implementations, the risk score is determined based on variable information, the tokens available, how many tokens are trusted, and so on. For example, if a customer has a strong authentication risk score and nothing has changed (e.g., no contact information updated, no suspected fraud, no theft reported), the customer may be challenged with information that normally would not be rendered for that particular type of authentication attempt. For example, if a customer logs in today and wants to set up online wires, the customer traditionally has to go through advanced access as a challenge. According to the various aspects discussed herein, for customers that have a strong authentication score (e.g., there are available tokens and nothing has changed), rather than asking for advanced access, the customer may be determined to be low risk and the system asks for a PIN as the authentication token. In a similar manner, if the customer is accessing through password reset where the customer is traditionally challenge with a PIN and the score is below a threshold level, the disclosed aspects might not rely on the PIN. Instead, the system may require the customer to perform a onetime passcode, FOB (with secure token), and so on. In another example, if the customer has a voiceprint on file, the system may ask the customer to authenticate using the voiceprint.

According to some implementations, the score may fluctuate up or down depending on historical information and/or current information related to the authentication tokens and the customer. Rules may be utilized and may be based on the score and other information, such as transaction type and usage of the tokens. The rules may provide instructions related to which security challenge to output, when to make the security challenge static, when to decrease a number of security challenges, when to increase a number of security challenges, and so on.

According to some implementations, real-time reporting related to the authentication attempts and challenges may be output to designed personnel on the financial entity. Such reporting may be utilized for assessment and analysis.

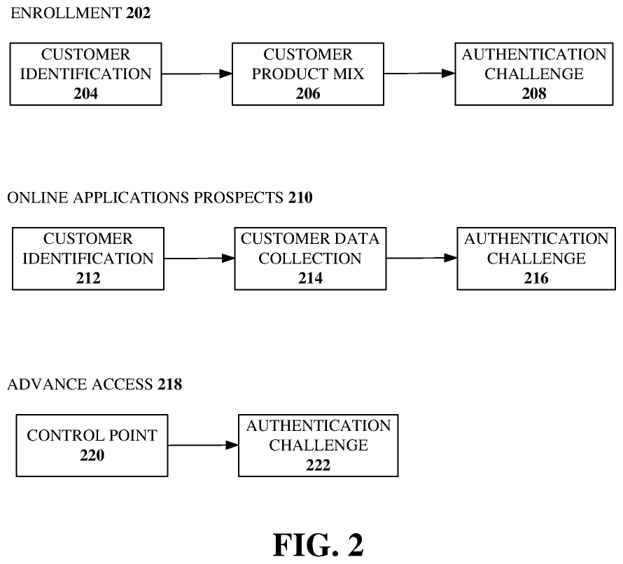

FIG. 2 illustrates examples of traditional authentication challenge types for different access channels. These traditional authentication challenges types are static and not interchangeable among the different access channels. Thus, it generally may be determined with certainty the type of security challenge that will be output as a function of the authentication challenge. The challenges discussed with respect to FIG. 2 are just a few examples to demonstrate the static nature of traditional authentication challenge types for the different access channels.

Authentication challenges presented during an enrollment phase 202 are illustrated at the top of FIG. 2. During the enrollment phase 202 there is a customer identification 204 step during which a determination is made whether the customer is a customer of the financial entity, whether the customer has the ability to enroll in online banking, and so on. If the customer identification 204 passes the various tests, a customer product list or a customer product mix 206 is accessed to determine the accounts associated with the customer. Based on the customer identification 204 and the product mix 206, an authentication challenge 208 is determined. According to some implementations, the authentication challenge 208 may include a Personal Identification Number (PIN), a Card Verification Value (CVV) if the customer has a credit card, Out Of Wallet (OOW) questions, a zip code, and so on. The data related to the authentication challenge 208 is not shared nor stored for use in downstream assessments according to the traditional enrollment phase 202.

Traditionally, the authentication challenge 208 is based on what products/services the customer has and may be represented as stacked rings. In an example, a Demand Deposit Account (DDA) is the highest type in the hierarchy, so a customer with a DDA may be presented with a personal identification number (PIN) challenge. The PIN challenge is presented even if the customer has credit cards, a mortgage, an IRA, and so on, and regardless of the information the customer provided during the authentication step. Thus, even if the customer entered their credit card number, if the customer has a DDA, the customer is still presented with a PIN challenge due to the manner in which the hierarchy and the logic operates (it is static).

Online applications prospects 210 for traditional authentication challenges is illustrated in the middle of FIG. 2. Customer identification 212 is determined and customer data collection 214 is performed. The data collected from the customer may be stored in a customer profile, but is not scored or assessed. An authentication challenge 216 is provided and may include OOW questions. Data about the authentication challenge 216 is not shared or stored for use in downstream assessments.

Traditional authentication challenge types for advance access 218 are illustrated at the bottom of FIG. 2. A control point 220 may include a request to access tax documents, initiate a wire transfer, and so on. Authentication challenges 222 may include an one-time passcode (if there is a trusted contact number on file), a FOB (if there is a FOB on file), and/or one or more OOW questions (if neither a trusted contact number nor a FOB are on file). Data about the authentication challenge 222 is not shared or stored for use in downstream assessments.

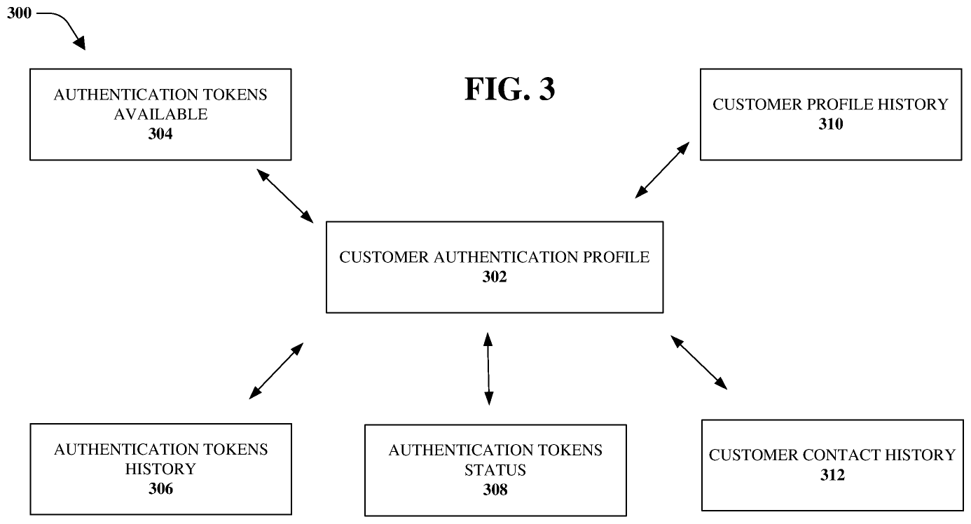

FIG. 3 illustrates example, non-limiting inputs for a customer authentication rules engine 300, according to an aspect. The authentication rules engine 300 (e.g., the system 100 of FIG. 1) may be an integrated engine that allows financial entities to become more agile and apply a more risk based approach to the authentication challenges being presented to customers. The authentication rules engine may be designed to incorporate all current and future authentication methods available and to apply enhance logic and data to make the challenge presentment dynamic, as compared to a traditional static model. By knowing what authentication methods are presented to customers and when the challenges were presented, additional logic may be applied to the authentication mechanisms. This may allow a financial entity to inject randomness into the authentication challenges and to consolidate all of the authentication mechanisms under one rules engine, allowing for presentment of authentication challenges to vary depending on customer, transactional, and other related information.

Additional logic and information may also be developed for the engine that would determine the level of trust for the customer (e.g., based on an internal indicator) as well as the ability to maintain set numbers of challenge mechanisms per day (e.g., OOW). Further authentication methods may be turned on or off dynamically in case of compromise (e.g., turn off debit/credit card authentication if retailer breach).

According to some implementations, examples of the initial data elements that may be included in the authentication rules engine include, but are not limited to, authentication challenge presented (pass/failed), transaction authentication challenge presented, date of the authentication challenge, and total number of authentication challenges per customer (pass/failed). Other data elements may include, but are not limited to, authentication methods available for each customer, such as trusted AA number on file, secure ID on file, Touch ID, and products owned by customer (for product hierarchy challenges). Further data elements may include but are not limited to customer profile change history (address, phone numbers), sign on history, security preference (customer elected enhanced authentication), trust level score (internal designation—would include parameters such as date of last contact info update, AA set for log in, EWS phone data), and customer device type.

Included in the customer authentication engine is a customer authentication profile 302. Inputs to the customer authentication profile 302 may include information related to the authentication tokens available 304, authentication tokens history 306, and/or authentication tokens status 308. Further inputs to the customer authentication profile 302 may include a customer profile history 310 and/or a customer contact history 312. The information input and retained by the customer authentication profile 302 may be updated based on detected changes, at regular intervals, at periodic intervals, at random intervals, and so on.

The authentication tokens available 304 may include product mix data, phone numbers, email addresses, OOW profiles, FOB, voiceprint, touch identification, biometrics, and so on. The authentication tokens history 306 may include date last used, pass/fail, number of presentments in an identified time period (e.g., 30 days, 90 days), a channel the authentication token was used in, a transaction type for which the authentication token was used, and so on. The authentication tokens status 308 may include trusted numbers, valid personal identification number, active credit card, active FOB, and so on.

The customer profile history 310 may include a new contact number, an address change, a PIN suspension, a new card activation, did the customer recently register, how many times a call center was contacted by this customer, and so forth. The customer contact history 312 may include a Voice Response Unit (VRU), an online login, enrollment, online application, and so on.

Accordingly, a determination is made as to the authentication tokens that are available for each customer and their product mix. There are various elements considered. For example, if a customer has a DDA, the challenge may include a PIN, a credit card number, a phone number, an email address, the ability for an OOW profile, and so on. Some international customers and certain sets of domestic customers, such as students, may have a thin profile and may fail the OOW challenges because they are not able to answer such a challenge. Thus, a different type of challenge may be presented to these customers.

At a high level and continuing the above example, a customer named Paul has a profile, and the available tokens available to Paul have been determined. Additional information may be added and associated with the tokens. For example, if it is known that Paul has a PIN, it may be determined when the PIN was last used, and cross-channels may be used based on a length of time since the PIN was last used. Thus, if Paul calls into a call center a challenge presented may be a PIN challenge. Accordingly, information may be retained that indicates Paul called and was successful answering the PIN challenge. Further, ATM usage by Paul may be known and information related to the ATM usage may be determined. Such information may include whether Paul performed a debit card purchase, did he withdraw money from an ATM, when was the ATM card last used, were there any issues with passing or failing, how many times was the challenge presented in a certain period of time, the challenge used in various types of transactions, and so on.

Continuing this example, the token status may be reviewed periodically or based on another interval. Further, the phone numbers may be reviewed on various intervals to determine if there has been a status change (e.g., did the customer change carriers, did the customer upgrade their device, and so on). There is also information that may be obtained based on vendor or other trusted third-party relationships that renders the information more trusted, or may indicate that the information should be removed from the customer's profile because something has changed, or looks risky or suspect. Further, if an email is sent to the customer and it is bounced back to the sender, the email address may not be valid anymore and may be removed automatically from the customer's profile. In a similar manner, if a credit card and/or a debit card is reported stolen, the information related to that card is removed from the customer profile.

As it relates to the customer profile history 310, there are certain activities that may raise concern related to fraud and risk based on the channel. This generally occurs through the phone channel because fraudsters may perceive the phone channel as the weakest link. Thus, if the fraudster contacts the “right” associate or provides enough information, the fraudster may be able to circumvent or successfully answer the authentication questions and may convince the associate to update contact information, perform a change of address, or another action that will make it easier for the fraudster to access the account.

The various aspects provided herein may review the customer profile history 310 to determine if there is anything going on with the customer externally or within their profile that would impact the score. In some implementations, there may need to be a stronger authentication challenge based on what has occurred. Alternatively, if everything remains consistent, instead of forcing through a stronger authentication method, it may be determined to ease up on some of the authentication challenges. This has a cost savings because there are costs associated with sending a one-time code, presenting the OOW challenge, and so on.

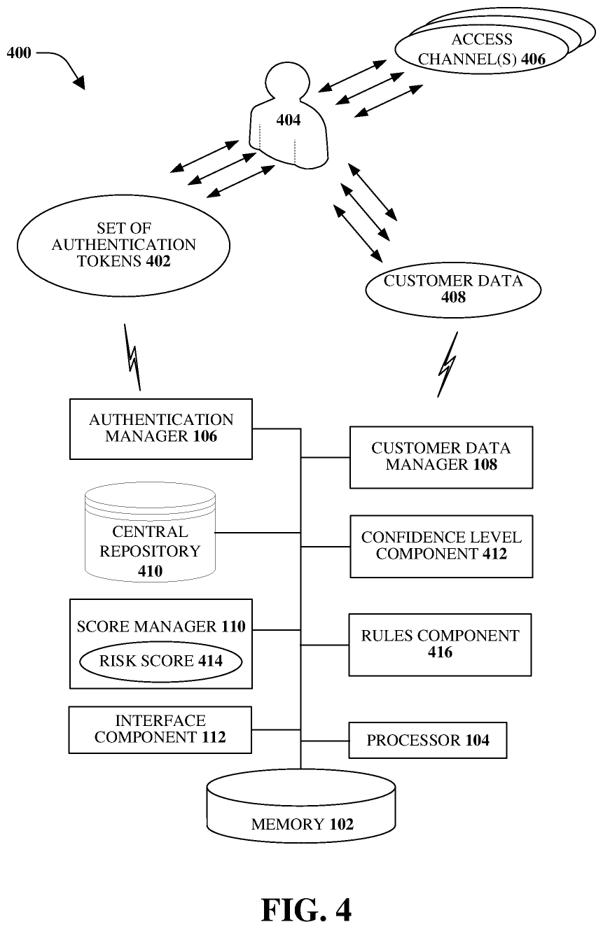

FIG. 4 illustrates an example non-limiting system 400 for dynamic cross-channel authorization token management, according to an aspect. The various aspects provided herein are configured to add robust risk assessments and real time decision making to online enrollment, online originations, username, and password help/reset processes, for example. Further, the disclosed aspects are configured to introduce business and policy rules to these entry points The rules may be utilized to determine to block the transaction or perform another action associated with the transaction (e.g., change a security challenge, add an additional security challenge, and so on). According to some implementations, all customers may be challenged due to the nature of the transaction they are attempting, although the complexity of those challenges may dynamically change. In addition, the disclosed aspects may be configured to prevent fraudsters from accessing sensitive customer data or using compromised credentials to gain access to an online banking program offered by a financial entity or other data needed to enroll or login.

As illustrated in FIG. 4, the authentication manager 106 may be configured to gather information related to a set of authentication tokens 402 that are available for a customer 404. The set of authentication tokens 402 include authentication tokens across all access channels 406 accessible by the customer 404. According to some implementations, the authentication tokens available may include product mix data, phone numbers, email addresses, OOW profile, FOB, voiceprint, touch identification, biometrics, and so on.

The customer data manager 108 may be configured to obtain data 408 related to the customer 404. According to some implementations, the customer may be identified based on credentials (e.g., a login/password pair, biometric identification, and so on). In another example, the customer may be identified based on information received from the customer's device (e.g., a Temporary Mobile Subscriber Identity (TMSI), an International Mobile Subscriber Identity (IMSI), an Internet Protocol (IP) address, and so on). Other manners of identifying the customer may also be utilized.

The data related to the customer may include customer level data and/or transaction level data. This data may include data such as, but not limited to, a date of a last challenge, the type of last challenge, whether the last challenge was successful, the number of times each of the authentication tokens were presented to the customer in a specific time frame, how many challenges were successful or failed over a period of time, and so on.

According to some implementations, the information related to the set of authentication tokens 402 and/or the customer data 408 may be retained in a central repository 410. For example, the authentication tokens available for a customer may be maintained in the central repository 410, as well as the available authentication tokens for other customers. Further, the data 408 related to the customer 404 (as well as other customers) may be stored in the central repository 410. In some implementations, the central repository 410 may be configured to retain current and future authentication methods available for each customer, as well as data related to the number of times each method has been presented to the customer and the result of the challenge (e.g., pass, fail).

According to some implementations, the central repository 410 may be retained by the at least one memory 102, or another system 400 component. According to some implementations, the central repository 410 may be retained external to the system 400, wherein the system 400 accesses the external source (e.g., external or remote central repository) as needed.

By having a central repository 410 the information related to the available authentication tokens for each customer may be maintained across channels. For example, if a brick-and-mortar store has certain information related to the customer/authentication token, that same information may be levered online or at a call center.

A confidence level component 412 may be configured to determine whether information related to the customer is trusted or is not trusted. For example, the confidence level component 412 may score each piece of information known about the customer on a scale (e.g., a scale of 1 to 10 where 10 is most trusted) or another manner of ranking the information. If the score or rank of a piece of information, or a set of information, is above a threshold trust level, a high level of trust may be assigned to the customer, for example.

According to some implementations, the confidence level component 412 may be configured to obtain more trusted numbers (and other information) from customers. In some cases, a one-time passcode may be desired and may be a default strongest authentication method. However, a one-time passcode relies on having contact numbers for customers and ensuring that those contract numbers are trusted. Thus, the confidence level component 412 or the customer data manager 108 may be configured to interact with a trusted third-party source (e.g., a wireless carrier or vendor) and verify whether the contact number (or other mobile data) provided by the customer is connected to the customer through some of the services provided by a vendor. Other information may also be obtained, such as a current state of the number.

For example, a profile for a customer, named Paul, is being built. Paul has a credit card, a checking account, and a mobile number on file. The system may associate a status to each of the credit card, the checking account, and the mobile number. A determination may be made whether the mobile number on file is trusted, if a PIN associated with the account is currently active, suspended, or reissued, and so on. There may also be additional authentication tokens, such as whether the customer has a voiceprint on file and whether the voiceprint is trusted or is not trusted. Thus, the system 400 may start to build in customer history as it relates to the authentication challenges. Other information may also be included, such as log in risk scores, customer device preferences, and so on.

The score manager 110 may be configured to determine an authentication risk score 414. The authentication risk score 414 may be determined based on the elements illustrated in FIG. 3. Examples of an authentication risk (score) may include data that has a positive impact on the authentication risk and/or data that has a negative impact on the authentication risk. Examples of data that may have a positive impact to the authentication risk include, but are not limited to, a number of available tokens, a trusted phone number, a validated email, OOW file, customer elected enhanced authentication, verified voiceprint, and so on. Examples of data that may have a negative impact to the authentication risk include, but are not limited to, a recent address change, a recent phone number change, a PIN suspended, fraud or mass compromise, failed attempts, login suspension/AV activity, and so on.

According to some implementations, if certain elements or authentication tokens are added that have a positive influence to a customer's score, it may change the type of authentication challenge that is presented. For example, if the system 400 validates a contact number as being trusted based on various relationships (e.g., third-party relationships, vendor relationships, and so on), it may have a positive impact to the authentication risk score 414. In another example, if the customer provides a voiceprint, it may be a considered a strong validation and may have a positive impact to the authentication risk score 414.

There may also be elements that have a negative impact or decrease in overall score. For example, if there was a recent change to an address and/or contact number, this change may have a negative impact to the authentication risk score (at least temporarily). Another example of a negative impact is if a PIN was suspended. Mass compromises (e.g., mass data breaches as covered in the media) where customers might be impacted may also have a negative impact to the score. In this situation, for those customers that have an account at the entity that experienced the mass compromise, the information may be included in the overall score (e.g., negative impact).

For example, if it is determined that the data breach lead to some identifiable information being compromised, there may an authentication risk score reduction for the appropriate customer(s) so that only strong authentication tokens are rendered. In this manner, it may be determined that they are the actual customer and not a fraudster relying on a PIN for password reset. In another example, if a customer has reported their credit card stolen, this may create an issue because a fraudster may attempt to go through one of the control points (e.g., call center) before the financial entity is able to reissue or suspend the credit card and its associated information. In this situation, there is a negative impact to the authentication risk score and the customer may need to successfully answer a strong security challenge (or more than one) in order to continue with the interaction. Additionally or alternatively, failed attempts with the authentication tokens may also have a negative impact (e.g., a decrease to) the authentication risk score.

As it relates to the authentication risk score 414, there are known pain points for customers, and particularly on certain elements such enrollment or password reset where it becomes difficult for the customer to gain access. With the disclosed aspects, different authentication challenges may be presented, such as allowing the customer to provide an email address and, if that address is on file, a link may be set to allow the customer to reset their password. Further, although the customer may reset their password, when the customer logs into the system, the customer may be asked for one or more additional tokens that are stronger in order for the system to validate the customer as a legitimate customer and not a fraudster.

The system 400 may also include a rules component 416 that may be configured to assign rules to one or more aspects of authentication. Some of the in-session authentication challenges tend to be advanced access and obtaining a one-time passcode. Thus, one or more rules may be established and enforced by the rules component 416 for different authentication tokens. For example, there may be a rule indicating that if a number of hits to a specific authentication token exceeds a predefined number in a certain period of time, it may indicate the system 400 may become predictable and fraudsters might recognize this predictability. For example, if a fraudster attempts to obtain a customer's tax documents, the challenge may be that the fraudster needs to have access to the phone number on file (which may have been changed by the fraudster previously). However, if the system 400 periodically switches the challenge message based on the customer profile, it may be more difficult for the fraudster to gain access. Accordingly, the various aspects discussed herein provide a more holistic view of the customer and has access to authentication tokens that might not be available today depending on the access channel.

According to some implementations, if a customer fails an access challenge, at a next attempt, two different forms of authentication may be required. For example, if on a first attempt a security question is output and the customer (or fraudster) answers the question incorrectly, on a second attempt, a one-time passcode may be used and, further, the customer may also need to provide their ATM PIN number. In this manner, if it was the customer that simply forgot the security answer, the customer may be able to successfully input the ATM PIN and the one-time passcode. However, if it was a fraudster attempting to gain unauthorized access, the fraudster may have a difficult time successfully providing the additional information. Thus, integrity of the security protocols may be maintained.

In another example, if the customer has advanced access during enrollment, the customer may have a better experience with stronger authentication. The information related to the advanced access may be shared with downstream applications and at a next high risk transaction where stronger authentication should be used, the stronger authentication may be something other than advanced access. In this situation, the customer profile may be reviewed and if a voiceprint is on file, the customer may need to provide a voice sample (or something else that is at a similar level as advanced access). A similar process may be utilized with account compromises (e.g., data breaches) and the compromised authentication token may be removed temporarily or permanently. For example, if the customer has a debit card reissued, or reported fraud on the account, if a PIN challenge is usually output, after the reissuance or reported fraud another type of authentication token may be output.

Specific, non-limiting, example authentication risk (rules) include, but are not limited to the following: If the customer has passed R number of authentication challenges of the same type within S period of days/attempts, where R and S are integers, then on a next attempt authenticate a different available authentication token should be used. If the customer has failed more than C number of times of any authentication token within D number of days, where C and D are integers, then require the customer to pass two (or more) authentication tokens on the next challenge. If the customer passed Advance Access during enrollment, then require a different authentication challenge or equal value on the next attempt. If customer account information has been compromised then do not challenge with account authentication tokens. It is noted that other rules may be established based on various policies and/or other considerations.

Based on the authentication risk score and/or the rule applied, the interface component 112 may be configured to output one or more authentication challenges selected based on the set of authentication tokens. The one or more authentication challenges selected may be independent of the access channel being used by the customer. Further, the one or more authentication challenges are selected to mitigate access by a fraudster. For example, the system 400 does not simply determine that since a user is attempting a first transaction type (e.g., access channel) the customer is presented with a first challenge. Instead, the system 400 reviews the available data, accesses the transaction risk and the customer risk, and selects the authentication challenge that will be used.

According to some implementations, the authentication challenge may vary depending on the device being used. For example, if the customer is using a mobile phone, the authentication challenge may be a one-time pass code, a voiceprint, or a touch id. Thus, rules may be configured to alter the challenge presented based on the device.

In some implementations, the rules may be configured to take into consideration the channel the customer is using to access the financial information. For example, if a customer calls into the contact center, the customer may be challenged with an account number and PIN. If the customer does not have a PIN, the customer places a telephone call to a phone banker and certain information needs to be provided by the customer. The phone banker may access various rules related to scoring the customer, which may be determined by the rules component 416. For example, the rules component 416 may determine how many tokens the customer needs to provide. In another example, the phone banker may be instructed to ask OOW questions. In traditional systems, this information is not communicated to downstream processes. Thus, if a customer is not able to provide a PIN, the customer may be a bad actor or a fraudster but may still gain access. However, according to the aspects disclosed herein, if the information is housed centrally, it may be determined when there was a PIN challenge and whether the customer has a valid PIN associated with their profile. It may also be determined that something may be suspect related to the PIN and, therefore, the customer may be asked to answer a different authentication challenge. According to an implementation, the customer may be asked to provide responses to two (or more) authentication challenges.

In such a manner, the authentication challenges may be random or unpredictable. If static (predictive as to what information the customer needs to provide), it makes it easier for fraudsters to circumvent security. Thus, making the security challenges random and less predictable may help prevent unauthorized access.

According to some implementations, the interface component 112 (as well as other interface components discussed herein) may provide a graphical user interface (GUI), a command line interface, a speech interface, Natural Language text interface, and the like. For example, a Graphical User Interface (GUI) may be rendered that provides a user with a region or means to load, import, select, read, and so forth, various requests and may include a region to present the results of the various requests. These regions may include known text and/or graphic regions that include dialogue boxes, static controls, drop-down-menus, list boxes, pop-up menus, as edit controls, combo boxes, radio buttons, check boxes, push buttons, graphic boxes, and so on. In addition, utilities to facilitate the information conveyance, such as vertical and/or horizontal scroll bars for navigation and toolbar buttons to determine whether a region will be viewable, may be employed. Thus, it might be inferred that the user did want the action performed.

The user may also interact with the regions to select and provide information through various devices such as a mouse, a roller ball, a keypad, a keyboard, a pen, gestures captured with a camera, a touch screen, and/or voice activation, for example. According to an aspect, a mechanism, such as a push button or the enter key on the keyboard, may be employed subsequent to entering the information in order to initiate information conveyance. However, it is to be appreciated that the disclosed aspects are not so limited. For example, merely highlighting a check box may initiate information conveyance. In another example, a command line interface may be employed. For example, the command line interface may prompt the user for information by providing a text message, producing an audio tone, or the like. The user may then provide suitable information, such as alphanumeric input corresponding to an option provided in the interface prompt or an answer to a question posed in the prompt. It is to be appreciated that the command line interface may be employed in connection with a GUI and/or Application Program Interface (API). In addition, the command line interface may be employed in connection with hardware (e.g., video cards) and/or displays (e.g., black and white, and Video Graphics Array (EGA)) with limited graphic support, and/or low bandwidth communication channels.

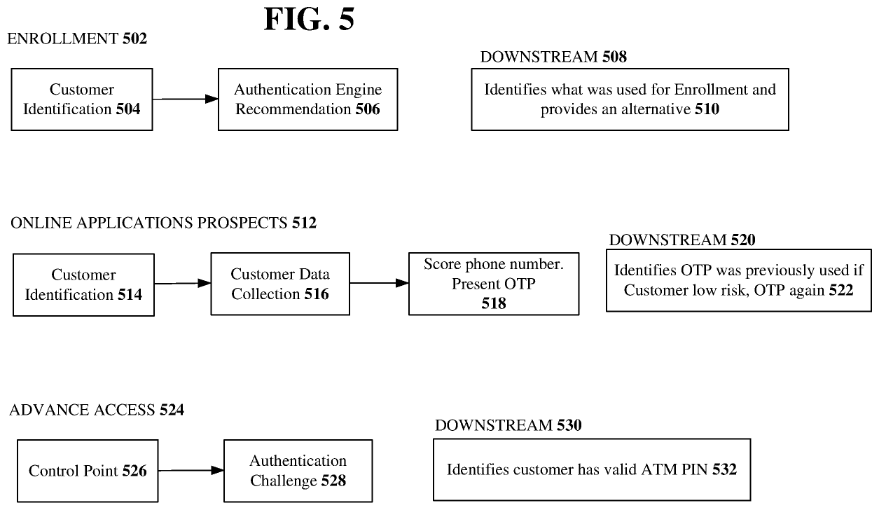

FIG. 5 illustrates example non-limiting authentication challenges that may be utilized with the disclosed aspects. The authentication challenges of FIG. 5 provide high-level implementations of how the various aspects may be applied in a dynamic manner and may be utilized with downstream applications.

As illustrated at the top of the figure, as the customer proceeds through enrollment 502, the customer is identified 504 and there may be a profile in the authentication engine (e.g., the system 100 of FIG. 1, the system 400 of FIG. 4, and so on) that determines a recommendation 506 regarding which challenge to present to the customer. The challenge that is recommended does not need to be based on the product hierarchy, as compared to the enrollment phase 202 of FIG. 2. The downstream impact 508 is that the other access channels know the challenge that was used for the enrollment 502 and an alternative challenge may be used 510. For example, an authentication challenge is used during enrollment and a rule has been established that indicates that if an authentication challenge is used during enrollment, the next challenge should be something different than the previously presented authentication challenge.

Online application prospects 512 are illustrated in the middle of FIG. 5. Customer identification 514 is performed as well as customer data collection 516. As the customer provides data elements, such as a phone number, a vendor may be contacted to ascertain whether the customer owns the number and, if it is verified as their number, the number becomes trusted right away. Thus, the phone number is scored 518 and, according to one implementation, instead of presenting an OOW, the downstream process 520 may utilize a different challenge since the number is trusted. According to one example, the challenge might be a one-time passcode (OTP). In another example, if an OTP was previously used and the customer is low risk, an OTP may be utilized again, as illustrated at 522, or an alternative recommendation may be presented based on various factors both internal and external.

For advance access 524, at illustrated at the bottom of FIG. 5, a control point 526 may be instances where a customer does not have trusted number or a FOB. In this case, the challenge presented 528 may be something other than a number or a FOB, such as an OOW challenge. Downstream 530, the next time a customer accesses a control point, if there is a PIN on file that is valid, and nothing has happened associated with that card or PIN, the PIN might be the challenge presented 532 rather than defaulting to the OOW challenge.

According to the various aspects, some of the challenges may be modified to make it easier for the customer because information related to previous challenges is known and shared among the different channels. Thus, on a subsequent access attempt, the challenge may be adapted. For example, if the customer was previously challenged with a weak form of authentication, a subsequent challenge may be stronger to validate the customer. For example, a customer may be permitted to reset a password by providing the email address on file. If this is allowed, when the customer logs in, the customer is challenged with a strong form of authentication to help make sure the person that reset the password is the legitimate customer.

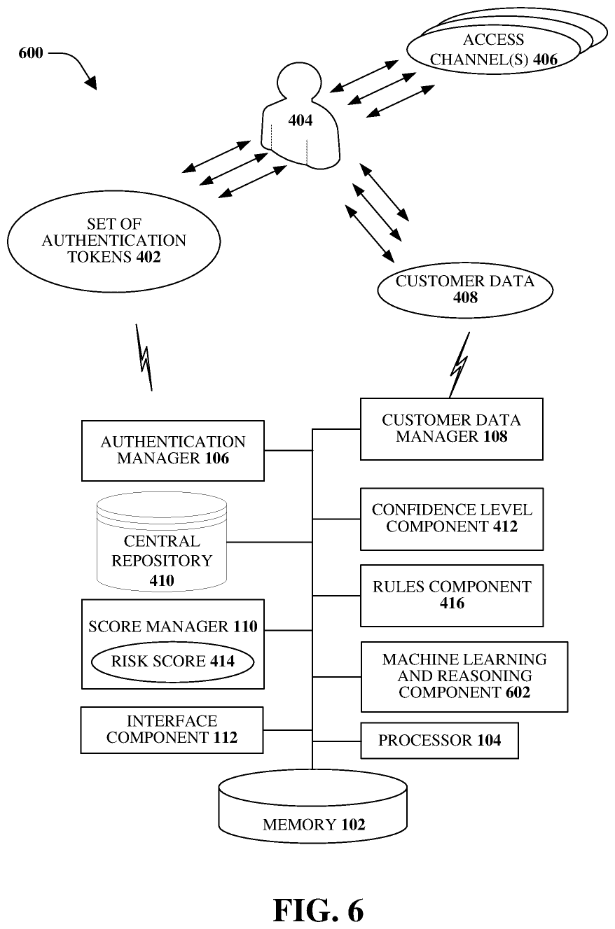

FIG. 6 illustrates an example, non-limiting system 600 that employs automated learning to facilitate one or more of the disclosed aspects. For example, a machine learning and reasoning component 602 may be utilized to automate one or more of the disclosed aspects. The machine learning and reasoning component 602 may employ automated learning and reasoning procedures (e.g., the use of explicitly and/or implicitly trained statistical classifiers) in connection with performing inference and/or probabilistic determinations and/or statistical-based determinations in accordance with one or more aspects described herein.

For example, the machine learning and reasoning component 602 may employ principles of probabilistic and decision theoretic inference. Additionally or alternatively, the machine learning and reasoning component 602 may rely on predictive models constructed using machine learning and/or automated learning procedures. Logic-centric inference may also be employed separately or in conjunction with probabilistic methods.

The machine learning and reasoning component 602 may infer which challenge to render regardless of a channel being used by the customer, whether to render more than one challenge, whether to change a score associated with a particular customer, and so on. Based on this knowledge, the machine learning and reasoning component 602 may make an inference based on a channel being used, a trust level associated with customer information, historical information associated with each customer, current information associated with the customer, fraud trends, and so forth.

As used herein, the term “inference” refers generally to the process of reasoning about or inferring states of the system, a component, a module, the environment, and/or customers (or devices associated with the customers) from a set of observations as captured through events, reports, data, and/or through other forms of communication. Inference may be employed to identify a specific context or action, or may generate a probability distribution over states, for example. The inference may be probabilistic. For example, computation of a probability distribution over states of interest based on a consideration of data and/or events. The inference may also refer to techniques employed for composing higher-level events from a set of events and/or data. Such inference may result in the construction of new events and/or actions from a set of observed events and/or stored event data, whether or not the events are correlated in close temporal proximity, and whether the events and/or data come from one or several events and/or data sources. Various classification schemes and/or systems (e.g., support vector machines, neural networks, logic-centric production systems, Bayesian belief networks, fuzzy logic, data fusion engines, and so on) may be employed in connection with performing automatic and/or inferred action in connection with the disclosed aspects.

The various aspects (e.g., in connection with facilitating sharing of challenge information across channels) may employ various artificial intelligence-based schemes for carrying out various aspects thereof. For example, a process for determining a risk score, whether a customer has just reset a password or performed another modification to their account, and so on, may be enabled through an automatic classifier system and process.

A classifier is a function that maps an input attribute vector, x=(x1, x2, x3, x4, xn), to a confidence that the input belongs to a class. In other words, f(x)=confidence(class). Such classification may employ a probabilistic and/or statistical-based analysis (e.g., factoring into the analysis utilities and costs) to prognose or infer an action that should be employed to determine what challenges should be rendered, whether a subsequent challenge should be of a higher difficulty level, a lower difficulty level, or a similar difficulty level as compared to a previous challenge, and so on. In the case of authentication challenges, for example, attributes may be a trust level associated with an authentication token and the classes may be information related to previous authentication challenges presented and the outcome of those challenges.

A support vector machine (SVM) is an example of a classifier that may be employed. The SVM operates by finding a hypersurface in the space of possible inputs, which hypersurface attempts to split the triggering criteria from the non-triggering events. Intuitively, this makes the classification correct for testing data that may be similar, but not necessarily identical to training data. Other directed and undirected model classification approaches (e.g., naïve Bayes, Bayesian networks, decision trees, neural networks, fuzzy logic models, and probabilistic classification models) providing different patterns of independence may be employed. Classification as used herein, may be inclusive of statistical regression that is utilized to develop models of priority.

One or more aspects may employ classifiers that are explicitly trained (e.g., through a generic training data) as well as classifiers that are implicitly trained (e.g., by observing user's responses to security challenges, by receiving extrinsic information, and so on). For example, SVM's may be configured through a learning or training phase within a classifier constructor and feature selection module. Thus, a classifier(s) may be used to automatically learn and perform a number of functions, including but not limited to determining according to a predetermined criteria which challenges should be rendered regardless of a channel being utilized, whether a particular authentication token is trusted, a level of trust, and so forth. The criteria may include, but is not limited to, historical information, current information, challenge attributes, and so forth.

Additionally or alternatively, an implementation scheme (e.g., a rule, a policy, and so on) may be applied to control and/or regulate which challenges to present, whether two or more challenges should be presented, and so on. In some implementations, based upon a predefined criterion, the rules-based implementation may automatically and/or dynamically interpret attributes associated with each access attempt. In response thereto, the rule-based implementation may automatically interpret and carry out functions associated with the authentication attempt by employing a predefined and/or programmed rule(s) based upon any desired criteria.

Methods that may be implemented in accordance with the disclosed subject matter, will be better appreciated with reference to the following flow charts. While, for purposes of simplicity of explanation, the methods are shown and described as a series of blocks, it is to be understood and appreciated that the disclosed aspects are not limited by the number or order of blocks, as some blocks may occur in different orders and/or at substantially the same time with other blocks from what is depicted and described herein. Moreover, not all illustrated blocks may be required to implement the disclosed methods. It is to be appreciated that the functionality associated with the blocks may be implemented by software, hardware, a combination thereof, or any other suitable means (e.g. device, system, process, component, and so forth). Additionally, it should be further appreciated that the disclosed methods are capable of being stored on an article of manufacture to facilitate transporting and transferring such methods to various devices. Those skilled in the art will understand and appreciate that the methods might alternatively be represented as a series of interrelated states or events, such as in a state diagram.

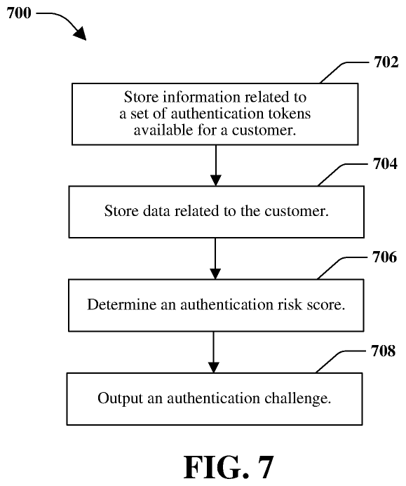

FIG. 7 illustrates an example, non-limiting method 700 for entry point management, according to an aspect. The various aspects discussed herein allow for appropriate authentication methods to be presented to customers based on transaction type as well as authentication risk token score. Further, the various aspects provide dynamic authentication presentment challenges using previous challenge history and information. This may make it more difficult for bad actors and fraudsters to obtain access to accounts as the authentication challenge will not be predictable under the dynamic presentment. The ability to turn off certain authentication tokens in case of a compromise, including customer level compromises, is also provided. Further, additional authentication challenges (e.g., PIN plus AA OTP code) may be introduced if certain risk or score levels satisfy a threshold level. If a customer's authentication token risk score shows that the customer is at a low risk of compromise, a reduced authentication may be applied to that customer. In addition, the disclosed aspects may be enabled for other user types (e.g., guest, delegates), which may streamline development and authentication challenges.

The method 700 in FIG. 7 may be implemented using, for example, any of the systems, such as the system 400 (of FIG. 4), described herein. Traditional authentication methods may vary by channel. For example, a user calling into a phone bank may be asked a first set of questions and, when that user is electronically requesting a password reset for an online application, a second set of questions may be asked. Further, in traditional authentication methods, the information requested by each channel are not maintained in a central location and other channels are not able to benefit from the information.

For example, digital channels may be limited as to the available authentication tokens with which to challenge customers. Such authentication tokens may include, but are not limited to, product hierarchy (e.g., personal identification number, zip, Card Verification Value code or number, and so on). Other examples of authentication tokens may include advance access/one time passcode, FOB, out of wallet questions, touch identification, and so forth. Additional authentication tokens may include voice identification, biometrics, and others.

Even though different authentication tokens are available for the digital channels, for example, the traditional deployment and use of the authentication tokens within the digital channels may be static. Further, each transaction that utilizes a challenge may be based on what has previously been determined as an appropriate challenge for that specific transaction type. Accordingly, the same set of challenges are output and the user (or fraudster) may anticipate the challenge that will be presented in order to access the account.

With continuing reference to FIG. 7, the method 700 starts at 702, when information related to a set of authentication tokens that are available for a customer is stored. The set of authentication tokens may include authentication tokens across all access channels accessible by the customer. For example, an authentication token may be utilized for an access channel regardless of whether that authentication token has traditionally been used for the access channel.

At 704, data related to the customer is stored. The data may be classified based on a level of trust assigned to the data. The data related to the customer may include a contact number, an email address, a home address, a mailing address, and other information. Further, the data related to the customer may include customer level data, transaction level data, or both customer level data and transaction level data. The level of trust may fluctuate, in real-time or substantially real-time, based on activity associated with the authentication tokens, the customer, the device, and so on.

An authentication risk score is determined, at 706, based on the information related to the set of authentication tokens and the data related to the customer. According to some implementations, having a strong authentication type on file (e.g., a voiceprint) may have a positive impact to the authentication risk score. Further, recent changes to a contact profile, multiple failed authentication attempts, and so on may have a negative impact to the authentication risk score.

At 708, an authentication challenge is output. The authentication challenge may be selected based on the set of authentication tokens and the authentication risk score. The output may be in any perceivable formatting including, but not limited to visual, audible, haptic, and so on. Further, although the authentication challenges and responses to the challenges have been described with respect to a manual interaction, the disclosed aspects are not limited to this implementation. Instead, the authentication challenge output may be selected such that automatic information is received related to the authentication challenge. For example, a device utilized by the consumer may automatically reply to the challenge, without intervention from the consumer.

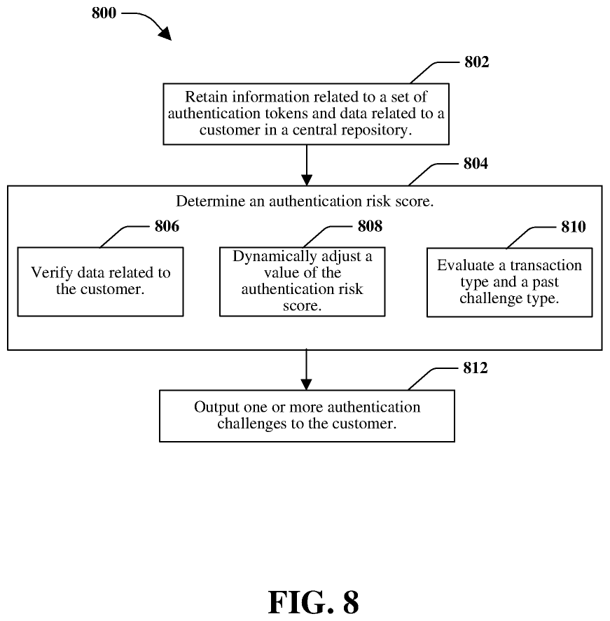

FIG. 8 illustrates an example non-limiting method 800 for or dynamic cross-channel authorization token management, according to an aspect. The method 800 in FIG. 8 may be implemented using, for example, any of the systems, such as the system 600 (of FIG. 6), described herein. According to some implementations, a transaction type (e.g., amount, timing, other contextual factors) may be combined with a past challenge history (e.g., content and success) as well as other factors (e.g., risky access point, origin, timing).

The method 800 starts at 802 when information related to a set of authentication tokens available to the customer and data related to the customer are stored in a central repository. The set of authentication tokens may include authentication tokens across all channels accessible by the customer. Further, the data related to the customer may be classified based on a level of trust assigned to the data, which may be determined based on historical data, current data, or combinations thereof. The level of trust may be determined in real-time or substantially real-time based on a request to access a customer financial account, according to an aspect. In some implementations, the level of trust may be determined at times other than when a request to access the customer financial account is received.

At 804, an authentication risk score is determined. According to an implementation, the data related to the customer may include a contact number (or other contact information, such as an email address). Further to this implementation, determining the authentication risk score may include verifying the contact number (or other data related to the customer, at 806, based on a relationship with a third-party source. For example, the third-party source may be a vendor with which the financial entity has a relationship and with which the customer has a relationship (e.g., the customer obtained their phone service from the vendor).

According to some implementations, determining the authentication risk score at 804 may include dynamically adjusting a value of the authentication risk score, at 808. For example, if it is determined that a recent change was made to the data related to the customer (e.g., a contact number update), a value associated with the authentication risk score may be reduced. Alternatively or additionally, if it is determined that a number of failed access attempts exceeds a threshold level, the authentication risk score may be reduced in value. Updated authentication tokens and/or stronger authentication tokens may have a positive impact to the authentication risk score.

In another implementation, determining the authentication risk score may include evaluating a transaction type and a past challenge history, at 810. For example, the information related to the authentication tokens may include historical information and current information, and the data related to the customer may include historical data and current data. Further to this example, determining the authentication risk score may include dynamically updating the authentication risk score based on the respective historical/current information and the respective historical/current data.

The method 800 continues, at 812, when one or more authentication challenges are output to the consumer. The one or more authentication challenges may be based on the authentication tokens available and the authentication risk score. The authentication challenge output is independent of an access channel used to access a financial account of the customer. Further, the authentication challenge output may be selected to mitigate access by a fraudster.

According to an implementation, outputting the authentication challenge may include selecting the authentication challenge based on a determination that another authentication challenge was utilized for more than a threshold number of subsequent interactions. Alternatively or additionally, outputting the authentication challenge may include interchanging the authentication tokens in the set of authentication tokens among different access channels.

As discussed herein, the various aspects relate to a central repository of available customer authentication tokens available for all channels. Data that may be included in the central repository may include customer and transaction level data, date and type of last challenge, was challenge successful, number of times each authentication was used in a specified time frame, and number of challenges successful/failed over a specified time frame. Additional information that may be included in the engine as it pertains to the authentication token may include last phone number update, address change, PIN suspension/change, date of voiceprint registration, whether the authentication token is trusted, and so on. Further information may include customer history as it relates to authentication challenges, login risk scores, customer device preferences, and so forth. The engine may create a score that is used to determine the authentication challenge(s) the customer will be presented with based on analysis of all of the variables.

The various aspects may enable digital channels, for example, to move to dynamic authentication presentment rather than static and would allow for digital channels to turn on or off certain authentication tokens for customers based on historical information as well as other information related to the authentication token. Control points that require authentication challenges may be presented with the appropriate authentication token based on a score/rules engine instead of a more traditional authentication challenge. For example, the rule may state that if this transaction is of type x then challenge with y. Although discussed with respect to digital channels, the various aspects disclosed herein may be expanded to other channels. Further, the disclosed aspects provide a holistic view of authentication tokens, challenges, success rates for customers, and may determine the authentication used for other channels.

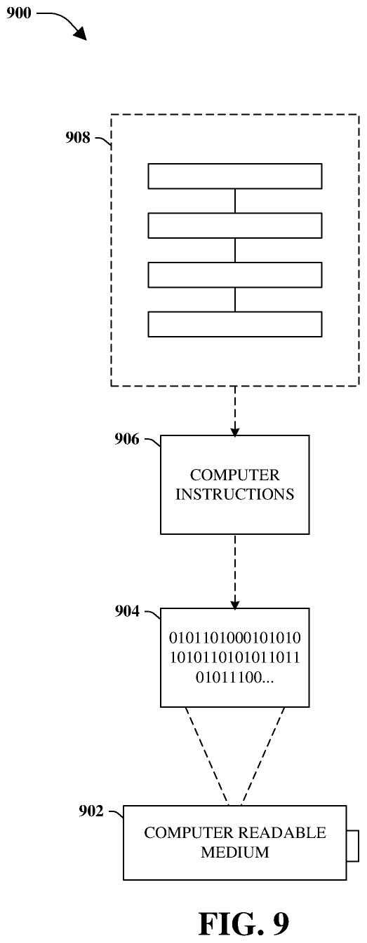

One or more implementations include a computer-readable medium including microprocessor or processor-executable instructions configured to implement one or more embodiments presented herein. As discussed herein the various aspects enable entry point management and dynamic cross-channel authorization token management. An embodiment of a computer-readable medium or a computer-readable device devised in these ways is illustrated in FIG. 9, wherein an implementation 900 includes a computer-readable medium 902, such as a CD-R, DVD-R, flash drive, a platter of a hard disk drive, and so forth, on which is encoded computer-readable data 904. The computer-readable data 904, such as binary data including a plurality of zero's and one's as illustrated, in turn includes a set of computer instructions 906 configured to operate according to one or more of the principles set forth herein.

In the illustrated embodiment 900, the set of computer instructions 906 (e.g., processor-executable computer instructions) may be configured to perform a method 908, such as the method 700 of FIG. 7 and/or the method 800 of FIG. 8, for example. In another embodiment, the set of computer instructions 906 may be configured to implement a system, such as the system 100 of FIG. 1 and/or the system 600 of FIG. 6, for example. Many such computer-readable media may be devised by those of ordinary skill in the art that are configured to operate in accordance with the techniques presented herein.

As used in this application, the terms “component”, “module,” “system”, “interface,” “manager,” and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter may be implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

FIG. 9 and the following discussion provide a description of a suitable computing environment to implement embodiments of one or more of the aspects set forth herein. The operating environment of FIG. 9 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, embodiments are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions are combined or distributed as desired in various environments.

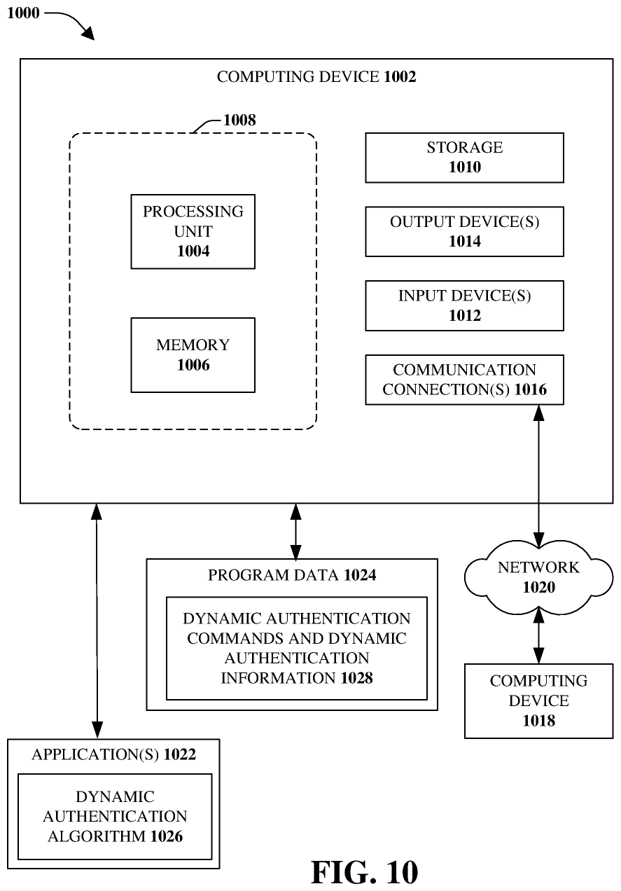

FIG. 10 illustrates a system 1000 that may include a computing device 1002 configured to implement one or more embodiments provided herein. In one configuration, the computing device 1002 may include at least one processing unit 1004 and at least one memory 1006. Depending on the exact configuration and type of computing device, the at least one memory 1006 may be volatile, such as RAM, non-volatile, such as ROM, flash memory, etc., or a combination thereof. This configuration is illustrated in FIG. 10 by dashed line 1008.

In other embodiments, the computing device 1002 may include additional features or functionality. For example, the computing device 1002 may include additional storage such as removable storage or non-removable storage, including, but not limited to, magnetic storage, optical storage, etc. Such additional storage is illustrated in FIG. 10 by storage 1010. In one or more embodiments, computer readable instructions to implement one or more embodiments provided herein are in the storage 1010. The storage 1010 may store other computer readable instructions to implement an operating system, an application program, etc. Computer readable instructions may be loaded in the at least one memory 1006 for execution by the at least one processing unit 1004, for example.

Computing devices may include a variety of media, which may include computer-readable storage media or communications media, which two terms are used herein differently from one another as indicated below.

Computer-readable storage media may be any available storage media, which may be accessed by the computer and includes both volatile and nonvolatile media, removable and non-removable media. By way of example, and not limitation, computer-readable storage media may be implemented in connection with any method or technology for storage of information such as computer-readable instructions, program modules, structured data, or unstructured data. Computer-readable storage media may include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which may be used to store desired information. Computer-readable storage media may be accessed by one or more local or remote computing devices (e.g., via access requests, queries or other data retrieval protocols) for a variety of operations with respect to the information stored by the medium.

Communications media typically embody computer-readable instructions, data structures, program modules, or other structured or unstructured data in a data signal such as a modulated data signal (e.g., a carrier wave or other transport mechanism) and includes any information delivery or transport media. The term “modulated data signal” (or signals) refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

The computing device 1002 may include input device(s) 1012 such as keyboard, mouse, pen, voice input device, touch input device, infrared cameras, video input devices, or any other input device. Output device(s) 1014 such as one or more displays, speakers, printers, or any other output device may be included with the computing device 1002. The input device(s) 1012 and the output device(s) 1014 may be connected to the computing device 1002 via a wired connection, wireless connection, or any combination thereof. In one or more embodiments, an input device or an output device from another computing device may be used as the input device(s) 1012 and/or the output device(s) 1014 for the computing device 1002. Further, the computing device 1002 may include communication connection(s) 1016 to facilitate communications with one or more other devices, illustrated as a computing device 1018 coupled over a network 1020.

One or more applications 1022 and/or program data 1024 may be accessible by the computing device 1002. According to some implementations, the application(s) 1022 and/or program data 1024 are included, at least in part, in the computing device 1002. The application(s) 1022 may include a dynamic authentication algorithm 1026 that is arranged to perform the functions as described herein including those described with respect to the system 400 of FIG. 4. The program data 1024 may include dynamic authentication commands and dynamic authentication information 1028 that may be useful for operation with the various aspects as described herein.

Although the subject matter has been described in language specific to structural features or methodological acts, it is to be understood that the subject matter of the appended claims is not necessarily limited to the specific features or acts described above. Rather, the specific features and acts described above are disclosed as example embodiments.

Various operations of embodiments are provided herein. The order in which one or more or all of the operations are described should not be construed as to imply that these operations are necessarily order dependent. Alternative ordering will be appreciated based on this description. Further, not all operations may necessarily be present in each embodiment provided herein.

As used in this application, “or” is intended to mean an inclusive “or” rather than an exclusive “or.” Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first,” “second,” or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising,” “comprises,” “including,” “includes,” or the like generally means comprising or including.

Although the disclosure has been shown and described with respect to one or more implementations, equivalent alterations and modifications will occur based on a reading and understanding of this specification and the annexed drawings. The disclosure includes all such modifications and alterations and is limited only by the scope of the following claims.

1. A system, comprising:
a processor; and
a memory that stores executable instructions that, when executed by the processor, facilitate performance of operations, comprising:
storing information related to a set of authentication tokens that are available for a customer, wherein the set of authentication tokens include authentication tokens across all access channels accessible by the customer;
storing data related to the customer, wherein the data is classified based on a level of trust assigned to the data;
determining an authentication risk score based on the information related to the set of authentication tokens and the data related to the customer; and
outputting an authentication challenge based on the set of authentication tokens and the authentication risk score, wherein the authentication challenge is independent of an access channel,
wherein a first customer has a first set of available authentication tokens, a second customer has a second set of available authentication tokens, and additional customers likewise have their own respective sets of available authentication tokens and the authentication tokens are available to each respective customer based on a type of account associated with the respective customer or which devices are associated with the respective customer,
wherein the determination as to which authentication challenge is output is dynamic and independent of the channel being used by the customer.

2. The system of claim 1, wherein the data related to the customer includes a contact number and determining the authentication risk score comprises verifying the contact number based on a relationship with a third-party source, wherein the level of trust assigned to the data is positive based on the verifying.

3. The system of claim 1, wherein determining the authentication risk score comprises reducing a value associated with the authentication risk score based on a determination that a recent change was made to the data related to the customer, wherein the system further comprises additional logic operative to inject randomness into authentication challenges.

4. The system of claim 1, wherein determining the authentication risk score comprises reducing a value associated with the authentication risk score based on a determination that a number of failed access attempts exceeds a threshold level.

5. The system of claim 1, wherein determining the authentication risk score comprises evaluating a transaction type and a past challenge history.

6. The system of claim 1, wherein outputting the authentication challenge comprises selecting the authentication challenge based on a determination that another authentication challenge was utilized for more than a threshold number of subsequent interactions.

7. The system of claim 1, wherein storing data related to the customer comprises:
obtaining a voiceprint from the customer;
receiving verification of the voiceprint from a trusted source associated with the customer; and
assigning a positive value to the voiceprint based on receiving verification.

8. The system of claim 1, wherein the information related to the authentication tokens and the data related to the customer comprise respective historical information and respective current information and determining the authentication risk score comprises dynamically updating the authentication risk score based on the respective historical information and the respective current information.

9. The system of claim 1, wherein outputting the authentication challenge comprises interchanging the authentication tokens in the set of authentication tokens among different access channels, and wherein the authentication challenges are interchangeable among different channels.

10. The system of claim 1, wherein the data related to the customer comprises customer level data, transaction level data, or both customer level data and transaction level data.

11. The system of claim 1, further comprises retaining the data related to the customer and the information related to a set of authentication tokens in a central repository.

12. A method, comprising:
retaining, by a system comprising a processor, information related to a set of authentication tokens available for a customer and data related to the customer in a central repository;
determining, by the system, an authentication risk score based on the information related to the set of authentication tokens and the data related to the customer;
selecting, by the system, an authentication challenge based on the set of authentication tokens and the authentication risk score; and
outputting the authentication challenge based on a determination that an attempt to access a financial account of the customer has been requested,
wherein if authentication tokens which have a positive influence on the authentication risk score are added, a different type of authentication challenge is subsequently outputted, wherein, in the event the token is a contact phone number, and the contact phone number is validated as being trusted based on various relationships, the authentication token will be considered a positive influence,
wherein the authentication risk score fluctuates depending on historical information and current information related to the authentication tokens.

13. The method of claim 12, wherein the information related to the set of authentication tokens comprises historical information and current information and the data related to the customer comprises historical data and current data.

14. The method of claim 12, wherein the set of authentication tokens includes authentication tokens across all access channels accessible by the customer.

15. The method of claim 12, wherein the data related to the customer is classified based on a level of trust assigned to the data.

16. The method of claim 12, wherein selecting the authentication challenge comprises:
determining past authentication challenge types presented to the customer; and
selecting an authentication challenge type that is different from the past authentication challenge types.

17. The method of claim 12, wherein the data related to the customer comprises customer level data, transaction level data, or both customer level data and transaction level data.

18. A non-transitory computer-readable storage device that stores executable instructions that, in response to execution, cause a system comprising a processor to perform operations, comprising:
storing information related to a set of authentication tokens that are available for a customer, wherein the set of authentication tokens includes authentication tokens across all access channels accessible by the customer, and the information includes historical information and current information for the set of authentication tokens;
storing data related to the customer, wherein the data is classified based on a level of trust assigned to the data, and the data includes historical data and current data related to the customer, wherein the level of trust fluctuates in real-time or substantially real-time based on activity associated with the authentication tokens;
determining in substantially real-time an authentication risk score based on the information related to the set of authentication tokens and the data related to the customer;
outputting authentication challenges based on what products or services the customer has representing authentication challenges as a hierarchy of stacked rings such that an initial challenge will be output regardless of the information the customer provides during an authentication step and secondary authentication challenges may also be output; and
outputting at least one secondary authentication challenge selected based on the set of authentication tokens and the authentication risk score, wherein the secondary authentication challenge is independent of an access channel,
wherein a first customer has a first set of available authentication tokens, a second customer has a second set of available authentication tokens, and additional customers likewise have their owns respective sets of available authentication tokens and the authentication tokens are available to each respective customer based on a type of account associated with the respective customer or which devices are associated with the respective customer,
wherein the determination as to which secondary authentication challenge is output is dynamic and independent of the channel being used by the customer,
wherein token status is reviewed periodically, and
information includes information obtained based on vendor or other trusted third-party relationships that renders the information more trusted or may indicate that the information should be removed from the customer's profile based upon a changed or risky status.

19. The non-transitory computer-readable storage device of claim 18, wherein the operations further comprise selecting the secondary authentication challenge based on a determination that another authentication challenge was utilized for more than a threshold number of subsequent interactions.

20. The non-transitory computer-readable storage device of claim 18, wherein the operations further comprise reducing a value associated with the authentication risk score based on a determination that a number of failed access attempts exceeds a threshold level.
